(19) United States
(12) Patent Application Publication
(10) Pub. No.: US 2012/0111771 A1
(43) Pub. Date: May 10, 2012

(54) PARTICLE GRADING AND COLLECTION DEVICE

(75) Inventor: CHUEH-KUAN WANG, TAINAN COUNTY (TW)

(73) Assignee: JIAN CHANG APPLIED MATERIALS CO., LTD., TAIPEI (TW)

(21) Appl. No.: 12/939,435

(22) Filed: Nov. 4, 2010

(51) Int. Cl. B07B 7/08

(52) U.S. Cl. 209/142

(57) ABSTRACT

A grading and collection device includes axial hollow body and suction unit, the hollow body has a first opening and a second opening defined in two ends thereof. The suction unit includes multiple hollow tubes with different inner diameters. The first ends of the hollow pipes located toward the first opening of the hollow body and the second ends of the hollow pipes extend through the second opening of the hollow body. Suction device is connected to each of the second ends of the hollow tubes. The particles of different sizes are sucked into the hollow pipes of different inner diameters. The grading and collection device is compact and efficient.

### FIELD OF THE INVENTION

The present invention relates to a particle grading and collection device, and more particularly, to an axial type particle grading and collection device with compact size and high efficiency.

### BACKGROUND OF THE INVENTION

A conventional particle grading and collection device creates a spiral air stream in the device and because the centrifugal force is larger than the gravity, so that the solid particles gain larger centrifugal forces along with the higher speed of the spiral stream. The particles are then separated from the air and cab be collected.

One of the conventional particle grading and collection devices known to applicant is shown in FIG. 1 and generally includes a tank with an inlet defined through the wall of the tank and the tank has a gradually reduced bottom. A suction pipe is inserted into the tank from the top of the tank and is the only outlet for the particle grading and collection device. The mixture of air and particles are supplied into the tank via the inlet and forms a downward vortex along the inside of the tank. An upward stream is formed in the suction pipe so that the smaller particles are sucked into the suction pipe and the larger particles are too heavy to raise and drop to the bottom of the tank. Therefore, the larger particles can be collected. This type of particle grading and collection devices has less efficiency and cannot meet most of the requirements. An improved particle grading and collection device is therefore developed and includes multiple separation sub-tanks located in a large tank and the outer sub-tanks are connected to the inner sub-tanks by different paths. The mixture of air and particles enters the outer sub-tanks and the larger and heavier particles will drop and the smaller and lighter particles enter the inner sub-tanks and the core sub-tanks with the air stream via the paths in sequence. The improved particle grading and collection device provides three grades of separation and collection so as to have better result.

Nevertheless, the improved particle grading and collection device includes the sub-tanks which are positioned at different radial positions in the large tank so that the whole device will be so large and costly. In addition, the distance of the paths is too long so that the time required is prolonged.

Furthermore, in the steps of Silicon wafer processing, a significant amount of powered waste is generated and the powdered waste includes carbon silicon and silicon. The carbon silicon and silicon are to be separated and collected so as to reuse them. The conventional method for separating and collecting the carbon silicon and silicon are chemical method and physical method which uses the particle grading and collection device.

However, the conventional particle grading and collection devices cannot precisely separate and collect the two different particles so that the carbon silicon and silicon cannot be re-used.

The present invention intends to provide a particle grading and collection device which improves the shortcomings of the conventional particle grading and collection devices.

### SUMMARY OF THE INVENTION

The present invention relates to a grading and collection device and comprises a tank which is a hollow body and has at least one air inlet defined therethrough. A first opening and a second opening are defined in two ends thereof. A collector and a suction device are connected to the first opening. A suction unit includes multiple hollow tubes with different inner diameters, wherein a first end of each of the multiple hollow tubes has a suction opening which faces the first opening of the hollow body, and a second end of each of the multiple hollow tubes extends through the second opening of the hollow body.

An auxiliary blowing device is connected to the hollow body and located beside the at least one air inlet. The auxiliary blowing device is a fan.

At least one inlet nozzle is connected to the wall of the hollow body and communicates with the second opening.

A fixing is connected to the hollow body and communicates with the second opening. A first collector and a first suction device are connected to the fixing.

A grading fixing is connected to the second end of each of the multiple hollow tubes. A second collector and a second suction device are connected to the grading fixing.

The primary object of the present invention is to provide a grading and collection device which has compact size, low manufacturing cost, time efficiency, and high grading and collecting efficiency.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional particle grading and collection device;

FIG. 2 shows the particle grading and collection device of the present invention;

FIG. 3 is a cross sectional view, taken along line A-A in FIG. 2;

FIG. 4 is a cross sectional view, taken along line B-B in FIG. 2, and

FIG. 5 shows the operation status of the particle grading and collection device of the present invention.

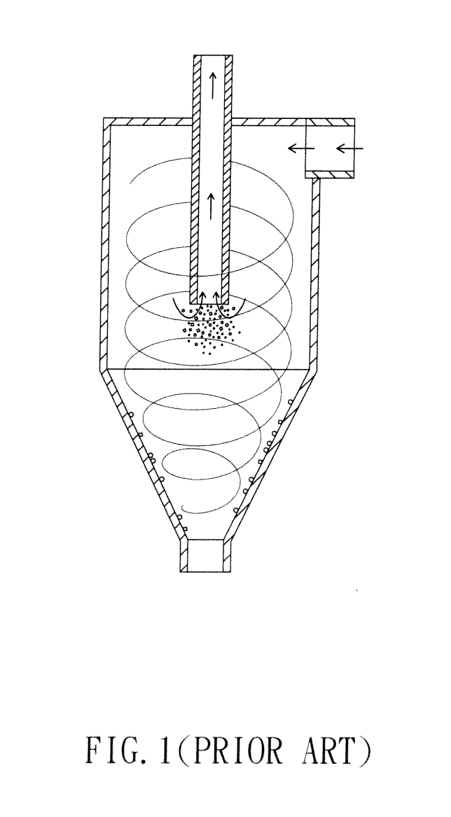

### DETAILED DESCRIPTION OF THE PREFERRED EMBODIMENT

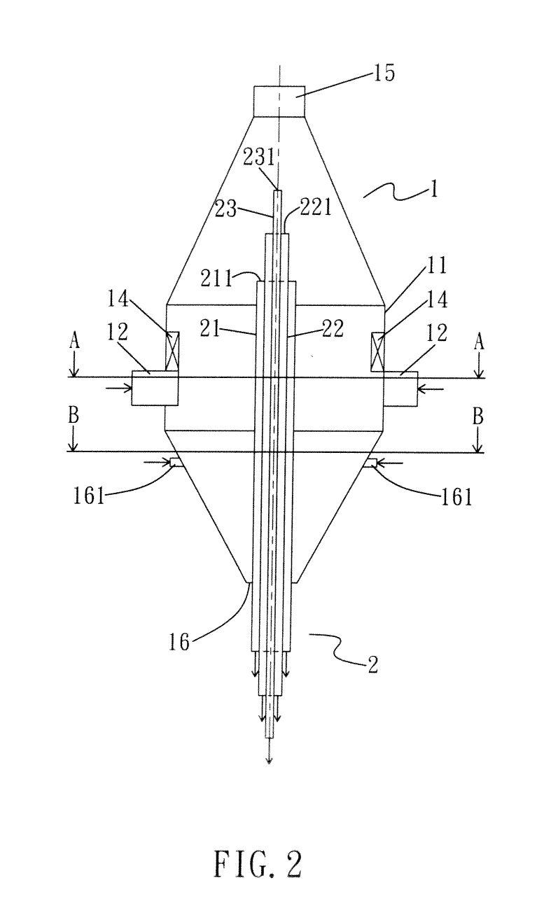

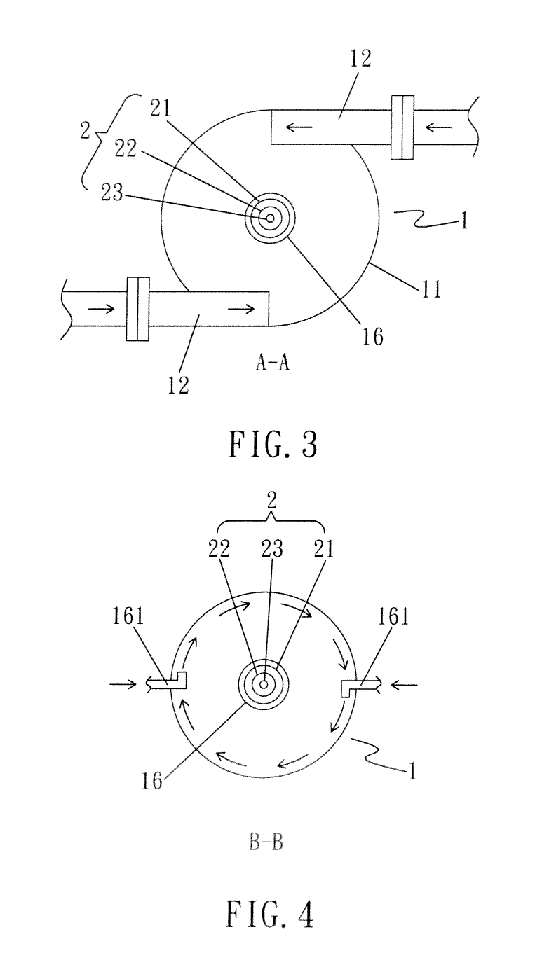

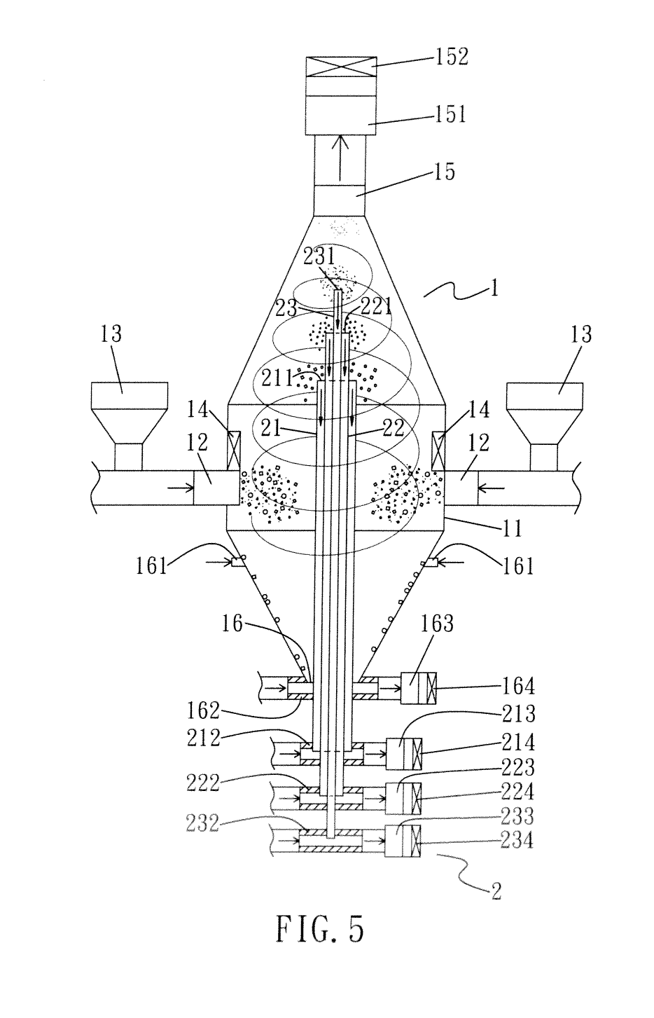

Referring to FIGS. 2 to 5, the particle grading and collection device of the present invention comprises a tank 1 which is a hollow body 11 and has two air inlets 12 defined therethrough. The air inlets 12 are tangent to the wall of the hollow body 11 and each air inlet 12 is connected with a feeding member 13. The powdered waste mixture is put in the feeing members 13 and the media of the spiral or vortex stream used in the device depends on the character of the mixture. For example, if the particles in the powdered waste are non-metallic material, the stream can be formed by air, if the particles in the powdered waste are metallic material, the stream can be formed by inert gas. Two auxiliary blowing devices 14 are respectively connected to the hollow body 11 and located beside the two air inlets 12. In this embodiment, the auxiliary blowing devices 14 are fans which assist to generate spiral or vortex stream in the hollow body 11. A first opening 15 is defined in a first end of the hollow body 11 and connected with a collector 151 and a suction device 152. A second opening 16 is defined in a second end of the hollow body 11. The inside of the hollow body 11 connected to the first and second openings 15, 16 are tapered. Two inlet nozzles 161 are connected to the tapered wall of the hollow body 11 and communicate with the second opening 16. A fixing 162 is connected to the hollow body 11 and communicates with the second opening 16. A first collector 163 and a first suction device 164 are connected to the fixing 162.

A suction unit 2 includes three hollow tubes 21, 22, 23 with different inner diameters. The hollow pipe 23 with the smallest inner diameter is inserted through the hollow pipe 22 with the medium inner diameters, and the hollow pipe 22 with the mediate inner diameter is inserted through the hollow pipe 21 with the largest inner diameters. The two ends of the hollow pipe 23 of the smallest inner diameter are extended out from the two respective ends of each of the hollow pipe 22 and the two ends of the hollow pipe 22 are extended out from two respective ends of the hollow pipe 21. The first end of each of the hollow tubes 21, 22, 23 has a suction opening 211/221/231 which faces the first opening 15 of the hollow body 11. A second end of each of the hollow tubes 21, 22, 23 extends through the second opening 16 of the hollow body 11. A grading fixing 212/222/232 is connected to the second end of each of the hollow tubes 21, 22, 23, and a second collector 213/223/233 and a second suction device 214/224/234 are connected to the grading fixing 212/222/232.

When the powdered waste mixture is delivered into the hollow body 11, the mixture is blown by the spiral or vortex stream in the hollow body 11. The particles with larger size will hit the inside of the hollow body 11 due to centrifugal force and drop toward the second opening 16. Some particles might attached on the tapered inside of the hollow body 11 and the inlet nozzles 161 can blow away from the tapered wall and toward the fixing 162. The first suction devices 163 then suck the particles to be collected by the first collectors 163.

The particles moved with the stream which brings the particles upward and the hollow tubes 21, 22, 23 suck the particles at different heights via the suction openings 211, 221, 231. In other words, the larger sized particles will be sucked into the suction opening 211, the mediate sized particles will be sucked into the suction opening 221, and the finest sized particles will be sucked into the suction opening 221

The particles of different sizes are graded by the spiral or vortex stream and collected by the suction openings 211, 221, 231 of the hollow tubes 21, 22, 23 at different heights. The rest of some of the finest particles are sucked by the suction device 152 at the first opening 15 and collected by the collector 151.

The hollow tubes 21, 22, 23 are axially connected in the hollow body 11 so that the whole size of the grading and collection device is compact. The components required for the grading and collection device is less than the conventional the grading and collection devices, so that the manufacturing cost can be reduced. The particles of different sizes are collected by different hollow tubes 21, 22, 23 so that the particles that are collected are well organized and convenient to be re-used. The powdered waste is graded and collected within short period of time and which increases the efficiency. The grading and collection device is used to grade and collect powered mixture of carbon silicon and silicon.

While we have shown and described the embodiment in accordance with the present invention, it should be clear to those skilled in the art that further embodiments may be made without departing from the scope of the present invention.

What is claimed is:

1. A grading and collection device comprising:
a tank being a hollow body which has at least one air inlet defined therethrough, a first opening defined in a first end of the hollow body and connected with a collector and a suction device, a second opening defined in a second end of the hollow body, and
a suction unit having multiple hollow tubes with different inner diameters, the hollow pipe with the smallest inner diameter being inserted through the two hollow pipes with larger inner diameters, two ends of the hollow pipe of the smallest inner diameter being extended out from two respective ends of each of the two hollow pipes with larger inner diameters, a first end of each of the multiple hollow tubes having a suction opening which faces the first opening of the hollow body, a second end of each of the multiple hollow tubes extending through the second opening of the hollow body.

2. The device as claimed in claim 1, wherein an auxiliary blowing device is connected to the hollow body and located beside the at least one air inlet.

3. The device as claimed in claim 1, wherein at least one inlet nozzle is connected to the wall of the hollow body and communicates with the second opening.

4. The device as claimed in claim I, wherein a fixing is connected to the hollow body and communicates with the second opening, a first collector and a first suction device are connected to the fixing.

5. The device as claimed in claim 1, wherein a grading fixing is connected to the second end of each of the multiple hollow tubes, a second collector and a second suction device are connected to the grading fixing.

6. The device as claimed in claim 1, wherein the grading and collection device is used to grade and collect powered mixture of carbon silicon and silicon.
